(19) United States
(12) Patent Application Publication
(10) Pub. No.: US 2024/0257424 A1
(43) Pub. Date: Aug. 1, 2024

(54) INFORMATION PROCESSING DEVICE, INFORMATION PROCESSING METHOD, DATA PRODUCTION METHOD, AND PROGRAM

(71) Applicant: NEC Corporation, Minato-ku, Tokyo (JP)

(72) Inventor: Soma SHIRAISHI, Tokyo (JP)

(73) Assignee: NEC Corporation, Minato-ku, Tokyo (JP)

(21) Appl. No.: 18/564,802

(22) PCT Filed: Jun. 2, 2021
(86) PCT No.: PCT/JP2021/020960

§ 371 Date: Nov. 28, 2023

(51) Int. Cl. G06T 11/60

(52) U.S. Cl. CPC G06T 11/60

(57) ABSTRACT

In order to, in recognition of an image, inhibit an image of an unregistered object from being erroneously recognized as an image of a registered object, an information processing apparatus includes: an acquisition means for acquires an original image that belongs to any of a plurality of classes; a determination means for determining a parameter that defines an image generation method; an image generation means for generating, from the original image, a new image with use of the parameter determined by the determination means; and a data generation means for generating data, the data including the new image and a label that is assigned to the new image and that corresponds to a class differing from a class to which the original image belongs.

### TECHNICAL FIELD

The present invention relates to an information processing apparatus, an information processing method, a data production method, and a program.

### BACKGROUND ART

A technique for applying an image identification process to a target image is known. For example, Patent Literature 1 discloses a training data generation apparatus capable of automatically generating training data that causes machine training to be carried out for evaluating an image in which a missing area has been subjected to repair processing. Further, Patent Literature 2 discloses an information processing apparatus that inhibits generation of redundant training data when generating new training data with use of existing training data.

### CITATION LIST

### Patent Literature

### [Patent Literature 1]

Japanese Patent Application Publication, Tokukai, No. 2017-058930

### [Patent Literature 2]

Japanese Patent Application Publication, Tokukai, No. 2020-091737

### SUMMARY OF INVENTION

### Technical Problem

As disclosed in Patent Literatures 1 and 2, there is a need to improve the identification accuracy of an image identification apparatus. However, there is a problem that, even in a case where training is carried out with use of training data that can be acquired, the identification accuracy does not improve as much as expected.

An example aspect of the present invention has been made in view of the above problem, and an example of an object thereof is to provide a technique that, in recognition of an image, inhibits an image of an unregistered object from being erroneously recognized as an image of a registered object.

### Solution to Problem

An information processing apparatus in accordance with an example aspect of the present invention includes: an acquisition means for acquiring an original image that belongs to any of a plurality of classes; a determination means for determining a parameter that defines an image generation method; an image generation means for generating, from the original image, a new image with use of the parameter determined by the determination means; and a data generation means for generating data, the data including the new image and a label that is assigned to the new image and that corresponds to a class differing from a class to which the original image belongs.

Further, an information processing apparatus in accordance with an example aspect of the present invention includes: an acquisition means for acquiring training data, the training data including a plurality of images, a class label assigned to each of the plurality of images, and identification information that is given to at least one or some images among the plurality of images and that is for identifying an image generation process involving the at least one or some images; and a training means for training a target model with reference to the training data acquired by the acquisition means, the target model including: a common layer that is applied regardless of the identification information; and a branch layer that is selectively applied in accordance with the identification information.

Further, an information processing apparatus in accordance with an example aspect of the present invention includes: an identification target image acquisition means for acquiring an identification target image; and an identification means for carrying out an identification process involving the identification target image acquired by the identification target image acquisition means by inputting the identification target image into a model trained with use of training data, the training data including an image that is assigned a label corresponding to a first class and an image that is generated from the image being assigned the label corresponding to the first class and that is assigned a label corresponding to any of one or more second classes, the one or more second classes differing from the first class.

An information processing method in accordance with an example aspect of the present invention includes: at least one processor acquiring an original image that belongs to any of a plurality of classes; the at least one processor determining a parameter that defines an image generation method; the at least one processor generating, from the original image, a new image with use of the determined parameter; and the at least one processor generating data, the data including the new image and a label that is assigned to the new image and that corresponds to a class differing from a class to which the original image belongs.

A data production method in accordance with an example aspect of the present invention includes: at least one processor acquiring an original image that belongs to any of a plurality of classes; the at least one processor determining a parameter that defines an image generation method; the at least one processor generating, from the original image, a new image with use of the determined parameter; and the at least one processor generating data, the data including the new image and a label that is assigned to the new image and that corresponds to a class differing from a class to which the original image belongs.

A program in accordance with an example aspect of the present invention is a program for causing a computer to function as an information processing apparatus, the program causing the computer to function as: an acquisition means for acquiring an original image that belongs to any of a plurality of classes; a determination means for determining a parameter that defines an image generation method; an image generation means for generating, from the original image, a new image with use of the parameter determined by the determination means; and a data generation means for generating data, the data including the new image and a label that is assigned to the new image and that corresponds to a class differing from a class to which the original image belongs.

An information processing method in accordance with an example aspect of the present invention includes: acquiring an identification target image; and carrying out an identification process involving the acquired identification target image by inputting the acquired identification target image into a model trained with use of training data, the training data including an image that is assigned a label corresponding to a first class and an image that is generated from the image being assigned the label corresponding to the first class and that is assigned a label corresponding to any of one or more second classes, the one or more second classes differing from the first class.

### Advantageous Effects of Invention

According to an example aspect of the present invention, it is possible to provide a technique that, in recognition of an image, inhibits an image of an unregistered object from being erroneously recognized as an image of a registered object.

### BRIEF DESCRIPTION OF DRAWINGS

FIG. 1 is a block diagram illustrating a configuration of an information processing apparatus in accordance with a first example embodiment of the present invention.

FIG. 2 is a flowchart illustrating a flow of an information processing method in accordance with the first example embodiment.

FIG. 3 is a block diagram illustrating a configuration of an information processing system in accordance with the first example embodiment.

FIG. 4 is a block diagram illustrating a configuration of an information processing apparatus in accordance with a second example embodiment of the present invention.

FIG. 5 is a view illustrating a method, carried out by the information processing apparatus in accordance with the second example embodiment, of generating a new image.

FIG. 6 is a flowchart illustrating a flow of an information processing method in accordance with the second example embodiment.

FIG. 7 is a block diagram illustrating a configuration of an information processing apparatus in accordance with a third example embodiment of the present invention.

FIG. 8 is a flowchart illustrating a flow of an information processing method S3 in accordance with the third example embodiment.

FIG. 9 is a flowchart illustrating a flow of an information processing method S4 in accordance with the third example embodiment.

FIG. 10 is a flowchart illustrating a flow of an information processing method S5 in accordance with the third example embodiment.

FIG. 11 is a block diagram illustrating a configuration of an information processing apparatus in accordance with a fourth example embodiment of the present invention.

FIG. 12 is a schematic diagram illustrating a configuration of a target model to be trained.

FIG. 13 is a block diagram illustrating a configuration of an information processing apparatus in accordance with a fifth example embodiment of the present invention.

FIG. 14 is a block diagram illustrating a configuration of an information processing apparatus in accordance with a sixth example embodiment of the present invention.

FIG. 15 is a schematic diagram illustrating a configuration of a target model having two processing layers.

FIG. 16 is a block diagram illustrating a configuration of an information processing apparatus in accordance with a seventh example embodiment of the present invention.

FIG. 17 is a flowchart illustrating a flow of an information processing method S6 in accordance with the seventh example embodiment.

FIG. 18 is a graph showing accuracy rates obtained by identifiers each of which is trained with use of different training data.

FIG. 19 is a configuration diagram for realizing an information processing apparatus and the like by software.

### DESCRIPTION OF EMBODIMENTS

### First Example Embodiment

A first example embodiment of the present invention will be described in detail with reference to the drawings. The present example embodiment is a basic form of an example embodiment described later.

### (Configuration of Information Processing Apparatus 1)

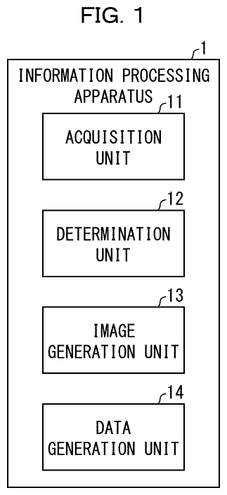

A configuration of an information processing apparatus 1 in accordance with the present example embodiment will be described with reference to FIG. 1. FIG. 1 is a block diagram illustrating the configuration of the information processing apparatus 1. As illustrated in FIG. 1, the information processing apparatus 1 includes an acquisition unit 11, a determination unit 12, an image generation unit 13, and a data generation unit 14.

The acquisition unit 11 is an aspect of the “acquisition means” recited in claims, the determination unit 12 is an aspect of the “determination means” recited in the claims, the image generation unit 13 is an aspect of the “image generation means” recited in the claims, and the data generation unit 14 is an aspect of the “data generation means” recited in the claims.

The acquisition unit 11 acquires an original image that belongs to any of a plurality of classes. A source from which the acquisition unit 11 acquires the original image is not limited. For example, an image recorded in an external database may be acquired, and an image recorded in a memory (not illustrated) that the information processing apparatus 1 has may be acquired. The original image is assigned a label corresponding to a class to which the original image belongs. The image acquired by the acquisition unit 11 is referred to as an original image. The acquisition unit 11 transmits the acquired original image to the determination unit 12.

In a case where the determination unit 12 has received the original image from the acquisition unit 11, the determination unit 12 determines a parameter that defines an image generation method. The image generation method is a method, carried out by the image generation unit 13, of generating a new image from an original image. The parameter includes, as an example, a parameter that defines a method of changing an image and a parameter that defines the degree of change to be made with respect to an original image in the image changing method. The determination unit 12 determines one or more parameters for one original image. The determination unit 12 transmits the original image and the determined parameter(s) to the image generation unit 13.

The image generation unit 13 generates, from the original image, a new image with use of the parameter determined by the determination unit 12. Specifically, in a case where the image generation unit 13 has received the original image and the parameter from the determination unit 12, the image generation unit 13 generates a new image by making a predetermined change based on the parameter to the original image. Examples of the predetermined change include a change of a hue, a change of a character, a change of a style, and the like. The new image generated by the image generation unit 13 is an image that is similar to the original image but belongs to a different class. The class to which the new image belongs differs from the class to which the original image belongs, but the contents of the new image are similar to those of the original image. Thus, the class to which the new image belongs is also referred to as a pseudo class. That is, the image generation unit 13 generates a new image which is similar to the original image and which belongs to the pseudo class. The image generation unit 13 transmits the label of the original image and the generated new image to the data generation unit 14. The image generation unit 13 may also transmit, to the data generation unit 14, the parameter used to generate the new image, together with the label of the original image and the generated new image.

In a case where the data generation unit 14 has received the new image from the image generation unit 13, the data generation unit 14 determines a label, which is to be assigned to the new image, corresponding to a class differing from the class to which the original image belongs. The data generation unit 14 generates data including the new image and the label that is assigned to the new image and that corresponds to a class differing from the class to which the original image belongs. That is, a set with a new image and a label assigned to the new image is referred to as data. The data generation unit 14 may generate the data that also includes a parameter.

Note that, in FIG. 1, the acquisition unit 11, the determination unit 12, the image generation unit 13, and the data generation unit 14 are illustrated as being collectively disposed as a single information processing apparatus 1, but do not necessarily have to be disposed in such a manner. That is, a configuration may be employed in which at least one or some of these units are disposed separately, and these units are connected to each other in a wired or wireless manner so that information communication can be carried out. Further, at least one or some of these units may be disposed on a cloud.

Further, the information processing apparatus 1 may have a configuration in which the information processing apparatus 1 includes at least one processor, and the processor reads a stored program and functions as the acquisition unit 11, the determination unit 12, the image generation unit 13, and the data generation unit 14. Such a configuration will be described later.

As described above, in the information processing apparatus 1 in accordance with the present example embodiment, a configuration in which the acquisition unit 11, the determination unit 12, the image generation unit 13, and the data generation unit 14 are included is employed. Thus, according to the information processing apparatus 1 in accordance with the present example embodiment, it is possible to generate a new image that belongs to a pseudo class. In addition, it is possible to train an identifier that identifies an image of an article with use of the generated new image. Therefore, in recognition of an image, the effect of making it possible to inhibit an image of an unregistered object from being erroneously recognized as an image of a registered object is obtained.

### (Information Processing Method S1)

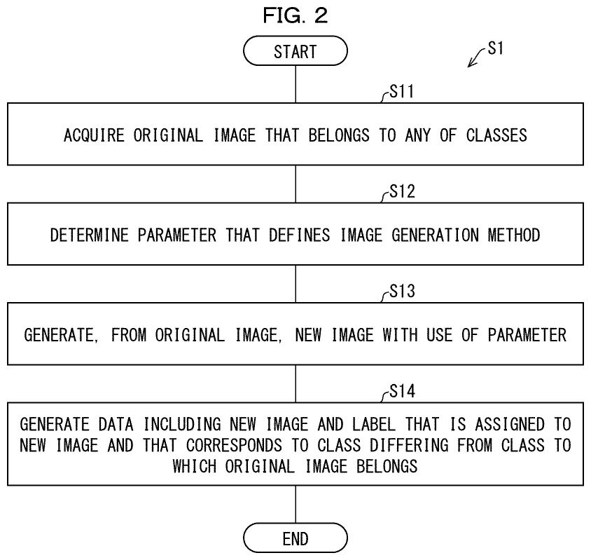

Next, an information processing method S1 carried out by the information processing apparatus 1 in accordance with the present example embodiment will be described with reference to FIG. 2. FIG. 2 is a flowchart illustrating a flow of the information processing method S1. As illustrated in FIG. 2, the information processing method S1 includes the following steps.

### (Step S11)

In step S11, at least one processor (acquisition unit 11) acquires an original image that belongs to any of a plurality of classes.

### (Step S12)

In step S12, the at least one processor (determination unit 12) determines a parameter that defines an image generation method.

### (Step S13)

In step S13, the at least one processor (image generation unit 13) generates, from the original image, a new image with use of the parameter determined by the determination means 12.

### (Step S14)

In step S14, the at least one processor (data generation unit 14) generates data including the new image and a label that is assigned to the new image and that corresponds to a class differing from a class to which the original image belongs. The generated data is recorded in a predetermined database.

Further, a data production method carried out by the information processing apparatus 1 includes the following steps as in the information processing method S1. That is, the data production method includes: a step of at least one processor acquiring an original image that belongs to any of a plurality of classes; a step of the at least one processor determining a parameter that defines an image generation method; a step of the at least one processor generating, from the original image, a new image with use of the determined parameter; and a step of the at least one processor generating data, the data including the new image and a label that is assigned to the new image and that corresponds to a class differing from the class to which the original image belongs.

As described above, in the information processing method S1 and the data production method in accordance with the present example embodiment, a configuration is employed in which each of the methods includes: at least one processor acquiring an original image that belongs to any of a plurality of classes; the at least one processor determining a parameter that defines an image generation method; the at least one processor generating, from the original image, a new image with use of the determined parameter; and the at least one processor generating data, the data including the new image and a label that is assigned to the new image and that corresponds to a class differing from a class to which the original image belongs. That is, according to the information processing method S1 in accordance with the present example embodiment, it is possible to generate training data capable of training an identifier that identifies an image of an article. Therefore, in recognition of an image, the effect of making it possible to inhibit an image of an unregistered object from being erroneously recognized as an image of a registered object is obtained.

### (Configuration of Information Processing System 2)

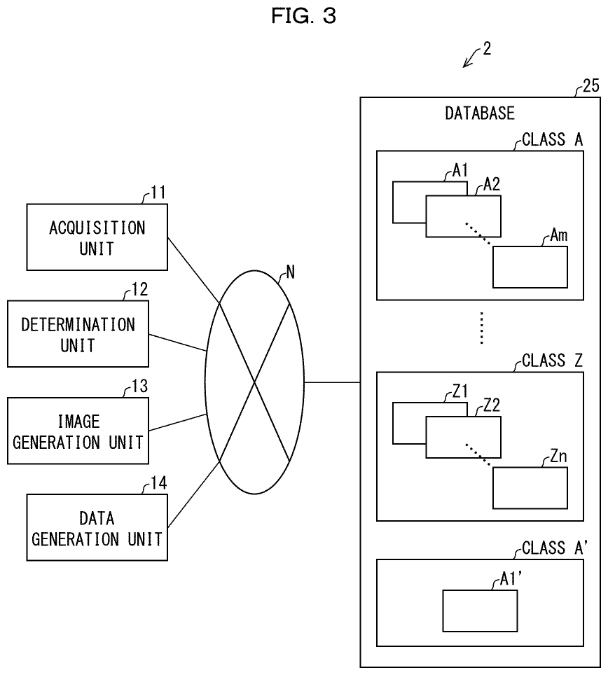

Next, an information processing system 2 in accordance with the present example embodiment will be described with reference to the drawing. FIG. 3 is a block diagram illustrating a configuration of the information processing system 2 in accordance with the present example embodiment.

As illustrated in FIG. 3, the information processing system 2 includes an acquisition unit 11, a determination unit 12, an image generation unit 13, a data generation unit 14, and a database 25. The acquisition unit 11, the determination unit 12, the image generation unit 13, and the data generation unit 14 are as previously described for the information processing apparatus 1. The acquisition unit 11, the determination unit 12, the image generation unit 13, the data generation unit 14, and the database 25 are connected to each other via a network N including the Internet so that information communication can be carried out. Note that it is not necessary that all of these units are connected via the network N, and some of these units may be directly connected in a wireless or wired manner. Further, at least one or some of these units may be disposed on a cloud.

The acquisition unit 11 acquires an original image from the database 25. A plurality of images classified into a plurality of classes are recorded in the database 25. For example, in the example illustrated in FIG. 3, images classified into different classes from class A to class Z are recorded. In the class A, a plurality of images A1, A2, . . . Am that belong to the same class A are recorded, and a label of an article name of, for example, A, is assigned to each of the images. In the class Z, a plurality of images Z1, Z2, . . . Zn that belong to the same class Z are recorded, and a label of an article name of Z is assigned to each of the images. That is, the classes are labeled and classified according to article to be identified by the identifier.

Data generated by the data generation unit 14 is recorded in the database 25. Alternatively, the data generated by the data generation unit 14 may be recorded in a database differing from the database 25. The data generated by the data generation unit 14 is, as an example, data in which a label A′ is assigned to an image A1′ generated from the original image A1 by the image generation unit 13. FIG. 3 illustrates an example of a state where the image A1′ which is assigned the label A′ is recorded as class A′ in the database 25.

In the information processing system 2 having the above-described configuration, it is possible to obtain the same effect as the effect obtained by the information processing apparatus 1 described above.

### Second Example Embodiment

A second example embodiment of the present invention will be described in detail with reference to the drawings. The same reference numerals are given to constituent elements which have functions identical with those described in the first example embodiment, and descriptions as to such constituent elements are omitted as appropriate. In the present example embodiment, an information processing apparatus 3 that identifies a class of a product will be described as an example.

For example, in a retail store or the like, an identification apparatus is introduced for use in, for example, inventory management and price management. This identification apparatus identifies a product through the use of an image of a product package. Retail stores need to handle products of new types and products of new packages in large numbers. A product of a new type or a product of a new package (both of which are referred to as a “new product”) can be identified by registering the type of the product and an image of the package as a new class in the identification apparatus.

However, it is difficult to register, with the identification apparatus, all of images of new products that arrive on a daily basis. Therefore, it is desirable that the identification apparatus be trained so that the identification apparatus can identify an unregistered new product as a new product that does not belong to an existing registration class. However, it is not easy to collect training data that causes the identification apparatus to be trained so that the identification apparatus can identify an unregistered new product as a product that resembles a registered product in appearance very closely, but differs from the registered product.

The information processing apparatus 1 in accordance with the present example embodiment is an apparatus that generates data for training an identification apparatus (identifier) for classes of products. This identification apparatus is, for example, an apparatus that identifies whether a certain image is an image that belongs to any of classes of products which have already been registered or an image that does not belong to any of the registered classes of products. The class refers to a group to which images of substantially the same product belong, and different labels are assigned to different classes. The class is set for each type of concrete product, and, as a label, for example, a trade name is assigned to each class. Note, however, that a product which has the same trade name but is packaged in an updated package is treated as a product of a different class, and a different label is assigned to the class.

In general, a product package is of a design consisting of a combination of an irregular shape, an irregular pattern, an irregular character string, an irregular color, and the like, without having a specific feature such as a cat or a car. In addition, there are many product packages designs of which are only partially changed. Therefore, in order to train an image identifier that classifies as to whether a product of a certain package is the same as or different from a product of an already-registered class, the image identifier is preferably trained with use of an image of a product package that is similar to the image of the product package of the registered class but belongs to a different class. The information processing apparatus 1 is an apparatus that generates an image for such training. An image of a package of a product is also referred to as a product image.

### (Configuration of Information Processing Apparatus 3)

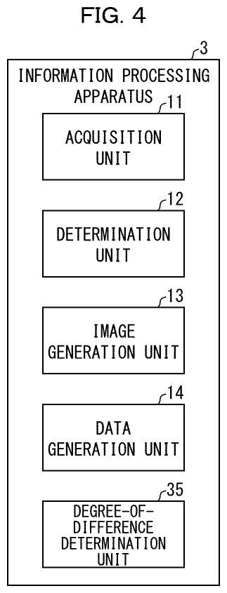

FIG. 4 is a block diagram illustrating a configuration of an information processing apparatus 3 in accordance with a second example embodiment. The information processing apparatus 3 includes an acquisition unit 11, a determination unit 12, an image generation unit 13, a data generation unit 14, and a degree-of-difference determination unit 35.

The acquisition unit 11 acquires, as an example, an original product image (hereinafter also referred to simply as an “original image”) that belongs to any of a plurality of registered product classes (hereinafter also referred to simply as a “class”) from a database of product images. A plurality of product images classified into any of a plurality of classes are stored in the database. The acquisition unit 11 transmits the acquired original image to the determination unit 12.

In a case where the determination unit 12 has received the original image from the acquisition unit 11, the determination unit 12 determines a parameter that defines a method of generating a new product image (hereinafter also referred to simply as a “new image”). Alternatively, in a case where the determination section 12 has received the original image and the parameter from the degree-of-difference determination unit 35, the determination unit 12 changes the parameter. After having determined or changed the parameter, the determination unit 12 transmits the original image and the parameter to the image generation unit 13.

Upon receiving the original image and the parameter from the determination unit 12, the image generation unit 13 generates a new image from the original image with use of the parameter. After having generated the new image, the image generation unit 13 transmits the original image and the new image to the degree-of-difference determination unit 35.

The degree-of-difference determination unit 35 derives a degree of difference between the original image and the new image generated from the original image and compares the degree of difference with a first threshold value. The degree-of-difference determination unit 35 is an aspect of the “degree-of-difference determination means” recited in the claims. In a case where the degree of difference between the original image and the new image is smaller than the first threshold value, the degree-of-difference determination unit 35 transmits the original image and the parameter to the determination unit. In a case where the degree of difference between the original image and the new image is equal to or larger than the first threshold value, the degree-of-difference determination unit 35 transmits the label of the original image and the new image to the data generation unit 14.

In a case where the data generation unit 14 has received the label of the original image and the new image from the degree-of-difference determination unit 35, the data generation unit 14 generates data including the new image and a label that is assigned to the new image and that corresponds to a class differing from the class to which the original product image belongs.

### (Method of Generating Image)

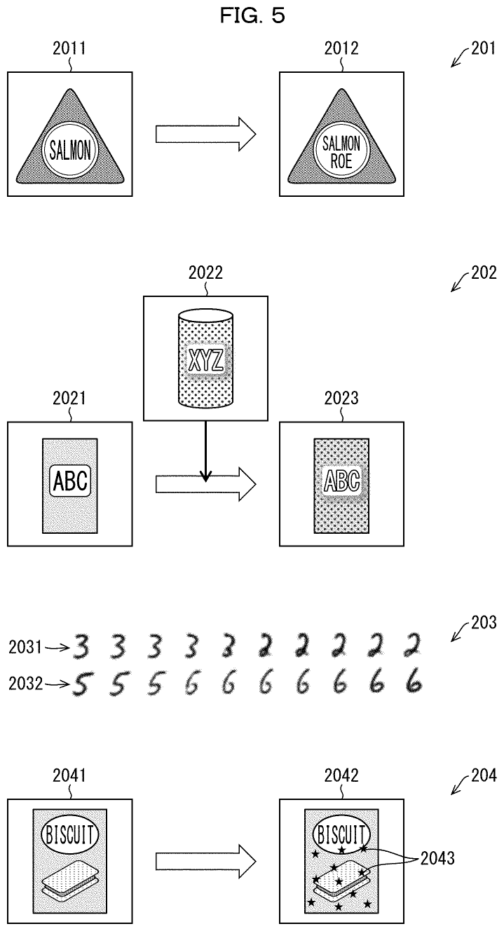

Next, a method by which the image generation unit 13 generates a new image from an original image will be described with reference to the drawing. FIG. 5 is a view illustrating an example of a method, carried out by the image generation unit 13 of the information processing apparatus 3, of generating a new image. The image generation unit 13 generates a new image with use of at least one selected from the group consisting of conversion of at least one or some of colors, replacement of at least one or some of characters, style conversion, interpolation by an image generation model, replacement or superimposition of a portion of an image. Specifically, the image generation unit 13 generates a new image with use of the parameter determined by the determination unit 12. The parameter includes: a method parameter M that specifies a method of generating a new image; and a conversion parameter T that, in a case where the method M is used to generate a new image, specifies a conversion value of image conversion by the method M or specifies a conversion degree of image conversion by the method M, a conversion range thereof, or the like.

Examples of the method parameter M include: a color conversion method M1 for converting a color; a character replacement method M2 for replacing characters with other characters; a style conversion method M3 for converting a combination of colors or the like while leaving a general shape and line; an inter-image interpolation method M4 using an image generation model; and an image replacement method M5 for replacing a portion of an image or superimposing another image or a pattern on a portion of an image. The determination unit 12 first determines the method parameter M and then specifically determines, for each of these methods, the conversion parameter T that specifies the conversion value or specifies the conversion degree, the conversion range, or the like.

The color conversion method M1 is, for example, a method in which a color of an original image is expressed in an HSV format and is changed in hue (Hue), saturation (Saturation), lightness (Value), contrast, or the like (not illustrated). For example, a new image having a different hue is generated by arranging hues of the original image in an annular ring shape in an HSV format and performing conversion into a color obtained by rotating the hues by a predetermined angle. In the color conversion method M1, in a case where hues are used, a conversion parameter T1 is an angle for rotating the hues arranged in an annular ring shape. The hues are arranged in the order of red, green, and blue in a clockwise direction, and the color of the original image is converted in accordance with the angle of the rotation.

The character replacement method M2 is, as illustrated in 201 of FIG. 5, a method of generating a new image 2012 by replacing a character (string) portion in an original image 2011 with other character (string). In a case where the character replacement method M2 is used, a conversion parameter T2 is a ratio of a character (string) to be replaced, a type of a character (string) after replacement, a font, or the like.

The style conversion method M3 is, as illustrated in 202 of FIG. 5, a method of generating a new image 2023 by combining other image 2022 with an original image 2021. As the style conversion method M3, for example, adaptive instance normalization (AdaIN) can be used to generate a new image. In a case where the style conversion method M3 is used, a conversion parameter T3 is a type of other image, a type of style, a color space value, or the like.

The inter-image interpolation method M4 is a method of generating an intermediate image by changing the amounts of features of two images and combining the two images. In the example illustrated in 203 of FIG. 5, an upper part 2031 therein indicates an image in which features of handwritten numbers 3 and 2 are combined. The feature of 3 increases toward the left-hand side, and the feature of 2 increases toward the right-hand side. A lower part 2032 therein is an image in which features of handwritten numbers 5 and 6 are combined in the same manner. The feature of 5 increases toward the left-hand side, and the feature of 6 increases toward the right-hand side. In a case where the inter-image interpolation method M4 is used, a conversion parameter T4 is a ratio between the feature amounts of two images. The degree of the ratio between the feature amounts of the two images may be determined by identification capability of a trained identifier. Alternatively, the ratio between the feature amounts of the two images may be determined in accordance with a pattern of change of a package.

The image replacement method M5 is a method of replacing a partial region of an image with a different image or pattern or a method of superimposing a different image or pattern on a partial region of an image. In the example illustrated in 204 of FIG. 5, a new image 2042 is generated by superimposing a star mark 2043 on an original image 2041. For the superimposition of a different image or pattern, an a-blend method or the like can be used. In a case where the image replacement method M5 is used, a conversion parameter T5 is a ratio of the partial region, designation of the different image or pattern, an a-value, or the like.

The image generation unit 13 may generate a plurality of new images from one original image. For example, the image generation unit 13 may generate a plurality of new images with use of a plurality of image generation methods for one original image, or may generate a plurality of new images by changing the conversion parameter T even in the same image generation method.

As described above, the image generation unit 13 can generate a new image from an original image by various methods, which are not limited to the above-described methods. Note that the image generation unit 13 may use a trained model using, for example, a neural network. In particular, in a case where, for example, the style conversion method M3, the inter-image interpolation method M4, or the like method is employed, the image generation unit 13 preferably uses a trained model using a neural network.

### (Degree-of-Difference Derivation Method)

Next, a method of deriving the degree of difference and a first threshold value will be described. The degree of difference is derived as a numerical value, and the numerical value is compared with a preset first threshold value. The method of deriving the degree of difference is not limited, and it is possible to use, for example, a method as below.

The degree of difference between an original image and a new image can be derived by using a neural network as an example. For example, the degree-of-difference determination unit 35 may input two images, which are the original image and the new image, into a trained image recognition neural network such as VGG16, derive an average or total value of differences between outputs of a plurality of layers, and use the average or total value as the degree of difference. Alternatively, the degree-of-difference determination unit 35 may carry out character recognition using a neural network, derive the degree of discrepancy of characters in the images, and use the degree of discrepancy as the degree of difference.

In addition, as a method using no neural network, the degree-of-difference determination unit 35 may derive an average or total value of differences between pixel values of two images and use the average or total value as the degree of difference. Alternatively, the degree of difference may be determined by a determination made by a determiner (user). For example, the degree-of-difference determination unit 35 displays the two images on a display, causes the determiner to input the degree of difference of the two images within a preset numerical range, and determines a numerical value input by the user to be the degree of difference. The range of the degree of difference to be input may be, for example, a normalized numerical range defined such that a case where the user determines that the two images are images of the same product package is 0 and that a case where the user determines that the two images are images of clearly different product packages is 1.

In a case where the user determines and where the degree of difference is small to the extent that the new image is determined to be almost the same as the original image, it is preferable that the image generation unit 13 generate a new image having a larger degree of difference. Thus, in a case where the degree of difference is smaller than the first threshold value, the determination unit 12 changes the parameter so that the degree of difference increases. The parameter change for increasing the degree of difference can be, for example, an increase in rotation angle in the case of the color conversion method M1. Further, in the case of the character replacement method M2, the parameter change can be an increase in number of characters to be converted or a change in character type such as Hiragana, Katakana, or Kanji. In the case of the image replacement method M5, the parameter change can be an increase of an area of the region targeted for the replacement.

Note that, in some cases, it is not certain whether the parameter change increases the degree of difference. Thus, in a case where the degree of difference is smaller than the first threshold value, the determination unit 12 may change the parameter in a random manner. In a case where, as a result of a determination as to the degree of difference of the new image generated with use of the randomly changed parameter, the degree of difference is determined to be larger, the parameter can be used continuously, or a parameter that further increases the degree of difference can be used.

Further, in a case where the degree of difference between an original image and a new image generated from the original image with use of a certain parameter is smaller than the first threshold value, the determination unit 12 may determine that the parameter is not to be used. For example, assume that the color conversion method M1 is used as the method parameter M, the conversion parameter T is “90 degrees” which is the rotation amount of the hue, and the degree of difference is smaller than the first threshold value. In this case, the determination unit 12 may determine that the conversion parameter T is not to be used. In such a case, the determination unit 12 can use, as the conversion parameter T, “180 degrees” for the rotation amount of the hue. By making such a determination, it is possible to reduce the possibility that a new image having a small degree of difference is generated.

The first threshold value is preset in accordance with the method of deriving the degree of difference. As an example, the first threshold value may be set after data indicating how much a new image generated from an original image with use of a certain parameter differs from the original image has been accumulated. Alternatively, the degree of difference obtained in a case where the user has compared the original image with the new image and determined that both of the images are different images may be set as the first threshold value. Further, the first threshold value may be changed by a result of training of an image identifier.

### (Effect of Information Processing Apparatus 3)

As described above, the information processing apparatus 3 in accordance with the present example embodiment employs, in addition to the configuration of the information processing apparatus 1 or 2 described above, a configuration in which the degree-of-difference determination means for deriving the degree of difference between an original image and a new image and comparing the degree of difference with a first threshold value is further included. Thus, according to the information processing apparatus 3 in accordance with the present example embodiment, in addition to the effect brought about by the information processing apparatus 1 in accordance with the first example embodiment, an effect of making it possible to reduce the possibility that a new image which is almost the same as an original image is generated is obtained.

### (Information Processing Method S2)

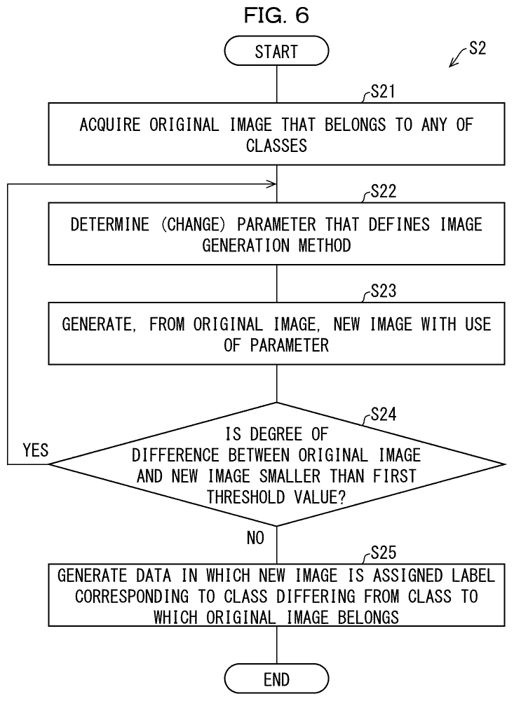

Next, an information processing method S2 carried out by the information processing apparatus 3 in accordance with the present example embodiment will be described with reference to FIG. 6. FIG. 6 is a flowchart illustrating a flow of the information processing method S2. As illustrated in FIG. 6, the information processing method S2 includes the following steps.

### (Step S21)

In step S21, the acquisition unit 11 acquires an original image that belongs to any class among a plurality of registered classes.

### (Step S22)

In step S22, the determination unit 12 determines (or changes) a parameter that defines an image generation method.

### (Step S23)

In step S23, the image generation unit 13 generates a new image from the original image with use of the parameter determined (or changed) by the determination means 12.

### (Step S24)

In step S24, the degree-of-difference determination unit 35 determines whether or not the degree of difference between the original image and the new image is smaller than the first threshold value. In step S24, in a case where it is determined that the degree of difference is smaller than the first threshold value (step S24: Y), the process returns to step S22, and the determination unit 12 changes the parameter. On the other hand, in step S24, in a case where it is determined that the degree of difference is not smaller than the first threshold value (step S24: N), the process proceeds to step S25.

### (Step S25)

In step S25, the data generation unit 14 generates data including the new image and a label that is assigned to the new image and that corresponds to a class differing from a class to which the original image belongs. The generated data is recorded in a predetermined database.

Note that, as mentioned earlier, in a case where it is determined in step S24 that the degree of difference is smaller than the first threshold value (step S24: Y), the determination unit 12 may determine that the parameter is not to be used, without returning to step S22.

### (Effect of Information Processing Method S2)

As described above, the information processing method S2 in accordance with the present example embodiment employs, in addition to the configuration of the information processing method S1 in accordance with the first example embodiment, a configuration in which the step S24 of the degree-of-difference determination unit 35 determining whether or not the degree of difference between an original image and a new image is smaller than the first threshold value. Thus, according to the information processing method S2 in accordance with the present example embodiment, in addition to the effect brought about by the information processing method S1 in accordance with the first example embodiment, an effect of making it possible to reduce the possibility that a new image which is almost the same as an original image is generated is obtained.

### Third Example Embodiment

A third example embodiment of the present invention will be described in detail with reference to the drawings. The same reference numerals are given to constituent elements which have functions identical with those described in the first and second example embodiments, and descriptions as to such constituent elements are not repeated.

### (Configuration of Information Processing Apparatus 4)

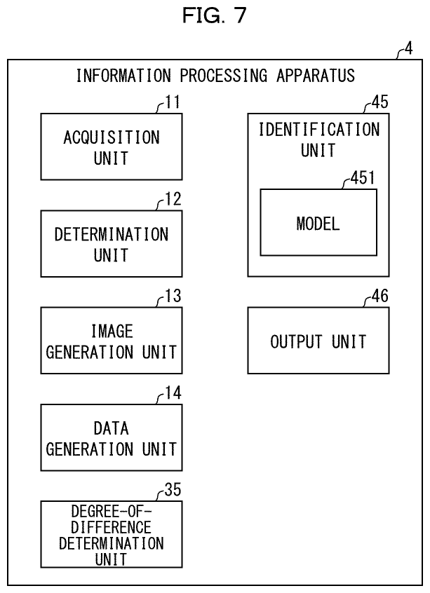

FIG. 7 is a block diagram illustrating a configuration of an information processing apparatus 4 in accordance with a third example embodiment. The information processing apparatus 4 includes an acquisition unit 11, a determination unit 12, an image generation unit 13, a data generation unit 14, a degree-of-difference determination unit 35, an identification unit 45, and an output unit 46. Since the acquisition unit 11, the determination unit 12, the image generation unit 13, and the data generation unit 14 are the same as the respective units described in the second embodiment, the descriptions as to these units will be omitted.

The degree-of-difference determination unit 35 has the same function as the degree-of-difference determination unit 35 in accordance with the information processing apparatus 3 described above, but differs in that the degree-of-difference determination unit 35 derives the degree of difference between an original image and a new image, and, in a case where the degree of difference is equal to or larger than the first threshold value, transmits the original image and the new image together with the parameter to the identification unit 45. Note that, in a case where the degree of difference is smaller than the first threshold value, the degree-of-difference determination unit 35 transmits the original image and the parameter to the determination unit. In this respect, the process is the same as the process carried out by the degree-of-difference determination unit 35 of the information processing apparatus 3 described above.

The identification unit 45 includes a model 451 that identifies an image. The identification unit 45 is an aspect of the “first identification means” recited in the claims.

The output unit 46 outputs, as an example, an identification result derived by the identification unit 45 to the outside. The output unit 46 is a wired or wireless output interface. Specifically, the output unit 46 is an output terminal or the like for wired connection or a communication transmitter or the like based on Bluetooth (registered trademark) standard or Wi-Fi (registered trademark) standard for wireless connection. The identification result output from the output unit 46 is displayed on, for example, a display.

The identification unit 45 will be described in detail below. The identification unit 45 derives an identification result by inputting a new image into the model 451 that identifies an image. The model 451 that identifies an image derives, as an example, the degree of similarity that indicates how similar to an original image the input new image is. In this case, the identification result is the degree of similarity between the input new image and the original image. The model 451 is an image identification model targeted for training. In particular, the model 451 is preferably an image identification model that is a training target which is trained with use of an image generated by the information processing apparatus 1, 3, or 4.

Further, the identification unit 45 compares the derived degree of similarity with a second threshold value. In a case where the identification result derived by the identification unit 45 is a result such that the degree of similarity between the new image and the original image is smaller than the second threshold value, the determination unit 12 changes the parameter so that the degree of similarity between the new image and the original image increases. Specifically, in a case where the identification result is a result such that the degree of similarity is smaller than the second threshold value, the identification unit 45 transmits the original image and the parameter to the determination unit 12. In a case where the determination unit 12 has received the original image and the parameter from the identification unit 45, the determination unit 12 changes the parameter so that the degree of similarity between the new image and the original image increases. The parameter change for increasing the degree of similarity can be, for example, a decrease in rotation angle in the case of the color conversion method M1. Further, in the case of the character replacement method M2, the parameter change can be a decrease in number of characters to be converted. Further, in the case of the image replacement method M5, the parameter change can be a decrease of an area of a region targeted for replacement.

As a method of deriving the degree of similarity, a method similar to the degree-of-difference derivation method that is carried out by the degree-of-difference determination unit 35 described in the second example embodiment can be used. However, the degree of similarity differs from the degree of difference in that the larger the degree to which both of the images differ, the smaller a numerical value of the degree of similarity. The second threshold value is preset in accordance with the method of deriving the degree of similarity.

The reason why, in a case where the identification result is a result such that the degree of similarity is smaller than the second threshold value, the determination unit 12 changes the parameter so that the degree of similarity between the new image and the original image increases is that the image generation unit 13 is caused to generate an image suitable for training an image identifier. The reason for this is that, even if the image identifier is trained with use of an image having a small degree of similarity (a large degree of difference), the image identifier cannot acquire the ability to identify an image having a large degree of similarity, and, in order to train the image identifier so as to acquire the ability to identify an image having a large degree of similarity, an image having a large degree of similarity needs to be used for the training.

In a case where an image identifier that identifies a class of an article (product or the like) is used as the model 451, the identification result derived by the identification unit 45 includes a class into which a new image is classified. In a case where the identification result is a result such that the new image is classified into a class differing from the class to which the original image belongs, the determination unit 12 preferably changes the parameter so that the degree of similarity between the new image and the original image increases. Specifically, in a case where the identification result derived by the identification unit 45 is a result such that the new image is classified into a class differing from the class to which the original image belongs, the identification unit 45 transmits the original image and the parameter to the determination unit 12. In a case where the determination unit 12 has received the original image and the parameter from the identification unit 45, the determination unit 12 changes the parameter so that the degree of similarity between the new image and the original image increases. With this configuration, it is possible to cause the image generation unit 13 to generate an image suitable for training the image identifier.

Alternatively, it is preferable that the identification result derived by the identification unit 45 be configured to include a class into which the new image is classified and the degree of reliability related to the classification into the class. In a case where the identification result is a result such that the new image is classified into a class differing from the class to which the original image belongs and that the degree of reliability related to the classification into the different class is larger than a third threshold value, the determination unit 12 preferably changes the parameter so that the degree of similarity between the new image and the original image increases.

Specifically, in a case where the identification result is a result such that the new image is classified into a class differing from the class to which the original image belongs and that the degree of reliability related to the classification into the different class is larger than a third threshold value, the identification unit 45 transmits the original image and the parameter to the determination unit 12. In a case where the determination unit 12 has received the original image and the parameter from the identification unit 45, the determination unit 12 changes the parameter so that the degree of similarity between the new image and the original image increases. With this configuration, it is possible to change the parameter only in a case where the degree of reliability is larger than the third threshold value, and it is possible to cause the image generation unit 13 to efficiently generate a suitable image. The degree of reliability of the class determined by the classification is, as an example, the probability that a new image is classified into a certain class. The third threshold value is preset in accordance with the method of deriving the degree of reliability.

Depending on the identification result derived by the identification unit 45, the determination unit 12 may change the parameter so that the degree of similarity between the new image and the original image increases. This is contradictory to the configuration in which, depending on the determination result derived by the above-described degree-of-difference determination unit 35, the determination unit 12 changes the parameter so that the degree of difference between the new image and the original image decreases. In the present example embodiment, the reason why a function having contradictory roles which are the degree-of-difference determination unit 35 and the identification unit 45 is provided is as follows. That is, in a case where only the degree-of-difference determination unit 35 is provided, only an image having a large degree of difference from the original image is generated, and there is a possibility that training for identifying an image having a small degree of difference cannot be carried out. In a case where only the identification unit 45 is provided, only an image having a large degree of similarity to the original image is generated, and there is a possibility that training for identifying an image having a small degree of similarity cannot be carried out. By providing both the degree-of-difference determination unit 35 and the identification unit 45, it is possible to generate various types of training images necessary for appropriate training.

Note that examples of the method of deriving the degree of similarity include a method of performing derivation using a neural network as described above, a method of performing derivation through image analysis, and a method of performing derivation by a determination made by the user. However, in a case where the identifier that is a training target identifies a difference of an artificial article such as a product package, it is preferable that the user determine an identification level desired by the user. Thus, it is preferable that the first threshold value, the second threshold value, and the third threshold value be set by the user in accordance with the identification level desired by the user.

### (Effect of Information Processing Apparatus 4)

As described above, the information processing apparatus 4 in accordance with the present third example embodiment employs, in addition to the configurations of the information processing apparatuses 1 to 3 described above, a configuration in which the identification unit 45 that derives an identification result by inputting a new image into the model 451 that identifies an image is further included. Thus, according to the information processing apparatus 4 in accordance with the present third example embodiment, in addition to the effects brought about by the information processing apparatuses 1 to 3 in accordance with the first example embodiment, an effect of making it possible to generate various types of images necessary for appropriate training is obtained.

### (Information Processing Method S3)

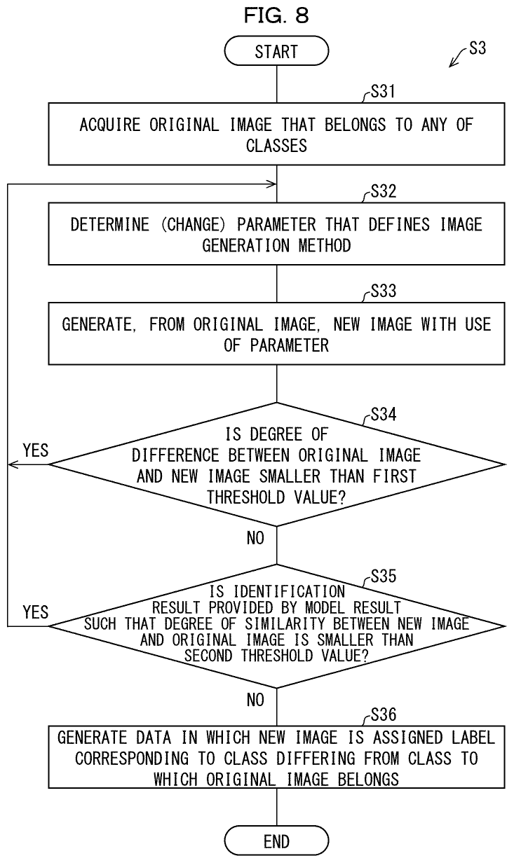

Next, an information processing method S3 carried out by the information processing apparatus 4 will be described with reference to the drawing. FIG. 8 is a flowchart illustrating a flow of the information processing method S3 in accordance with the present example embodiment. As illustrated in FIG. 8, among the steps of the information processing method S3, step S31, step S32, step S33, and step S34 are the same as step S21, step S22, step S23, and step S24 of the information processing method S2 described above.

In step S34, in a case where it is determined that the degree of difference is smaller than the first threshold value (step S34: Y), the process returns to step S32, and the determination unit 12 changes the parameter. On the other hand, in step S34, in a case where it is determined that the degree of difference is equal to or larger than the first threshold value (step S34: N), the process proceeds to step S35.

### (Step S35)

In step S35, the identification unit 45 determines whether or not the identification result provided by the model 451 is a result such that the degree of similarity between the new image and the original image is smaller than the second threshold value.

In step S35, in a case where it is determined that the degree of similarity between the new image and the original image is smaller than the second threshold value (step S35: Y), the process returns to step S32, and the determination means 12 changes the parameter so that the degree of similarity between the new image and the original image increases. In step S35, in a case where it is determined that the degree of similarity between the new image and the original image is equal to or larger than the second threshold value (step S35: N), the process proceeds to step S36.

### (Step S36)

In step S36, the data generation unit 14 generates data in which the new image is assigned a label corresponding to a class differing from the class to which the original image belongs. The generated data is recorded in a predetermined database.

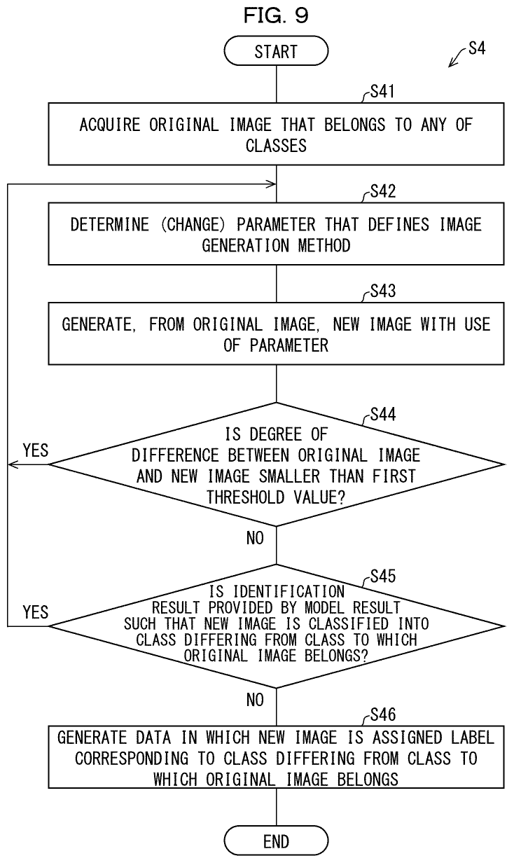

Next, an information processing method S4 carried out by the information processing apparatus 4 will be described with reference to the drawing. FIG. 9 is a flowchart illustrating a flow of the information processing method S4 in accordance with the present example embodiment. As illustrated in FIG. 9, among the steps of the information processing method S4, step S41, step S42, step S43, and step S44 are the same as step S31, step S32, step S33, and step S34 of the information processing method S3 described above.

### (Step S45)

In step S44, in a case where it is determined that the degree of difference is equal to or larger than the first threshold value (step S34: N), the process proceeds to step S45. In step S45, the identification unit 45 determines whether or not the identification result provided by the model 451 is a result such that the new image is classified into a class differing from the class to which the original image belongs.

In step S45, in a case where it is determined that the new image is classified into a class differing from the class to which the original image belongs (step S45: Y), the process returns to step S42, and the determination means 12 changes the parameter so that the degree of similarity between the new image and the original image increases. In step S45, in a case where it is determined that the new image is not classified into a class differing from the class to which the original image belongs (step S45: N), the process proceeds to step S46.

### (Step S46)

In step S46, the data generation unit 14 generates data in which the new image is assigned a label corresponding to a class differing from the class to which the original image belongs. The generated data is recorded in a predetermined database.

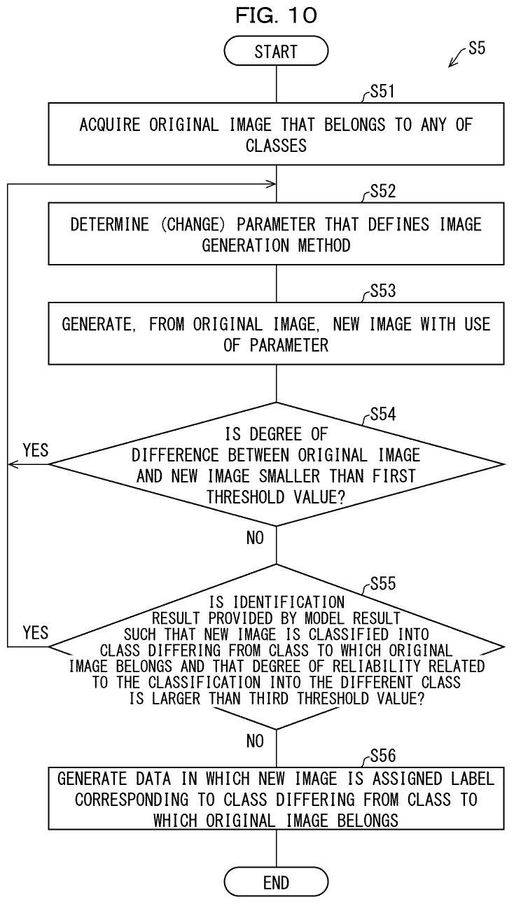

Next, an information processing method S5 carried out by the information processing apparatus 4 will be described with reference to the drawing. FIG. 10 is a flowchart illustrating a flow of the information processing method S5 in accordance with the present example embodiment. As illustrated in FIG. 10, among the steps of the information processing method S5, step S51, step S52, step S53, and step S54 are the same as step S41, step S42, step S43, and step S44 of the information processing method S4 described above.

### (Step S55)

In step S54, in a case where it is determined that the degree of difference is equal to or larger than the first threshold value (step S54: N), the process proceeds to step S55. In step S55, the identification unit 45 determines whether or not the identification result provided by the model 451 is a result such that the new image is classified into the class differing from the class to which the original image belongs and that the degree of reliability related to the classification into the different class is larger than the third threshold value.

In step S55, in a case where it is determined that the new image is classified into the class differing from the class to which the original image belongs and that the degree of reliability related to the classification into the different class is larger than the third threshold value (step S55: Y), the process returns to step S52, and the determination means 12 changes the parameter so that the degree of similarity between the new image and the original image increases.

In step S55, in a case where it is determined that the new image is not classified into the class differing from the class to which the original image belongs or it is determined that the new image is classified into the class differing from the class to which the original image belongs, but the degree of reliability related to the classification into the different class is not larger than the third threshold value (step S55: N), the process proceeds to step S56.

### (Step S56)

In step S56, the data generation unit 14 generates data in which the new image is assigned a label corresponding to the class differing from the class to which the original image belongs. The generated data is recorded in a predetermined database.

### (Effect of Information Processing Methods S3, S4, and S5)

As described above, in the information processing methods S3 to S5 in accordance with the present example embodiment employs, in addition to the configuration of the information processing method S1 in accordance with the first example embodiment, a configuration in which steps S35, S45, and S55 of the identification unit 45 determining whether or not the identification result provided by the model 451 is a result such that the degree of similarity between the new image and the original image is smaller than the second threshold value are included. Thus, according to the information processing methods S3 to S5 in accordance with the present example embodiment, in addition to the effect brought about by the information processing method S1 in accordance with the first example embodiment, an effect of making it possible to generate various types of images necessary for appropriate training is obtained.

### Fourth Example Embodiment

A fourth example embodiment of the present invention will be described in detail with reference to the drawings. The same reference numerals are given to constituent elements which have functions identical with those described in the first to third example embodiments, and descriptions as to such constituent elements are not repeated.

### (Configuration of Information Processing Apparatus 5)

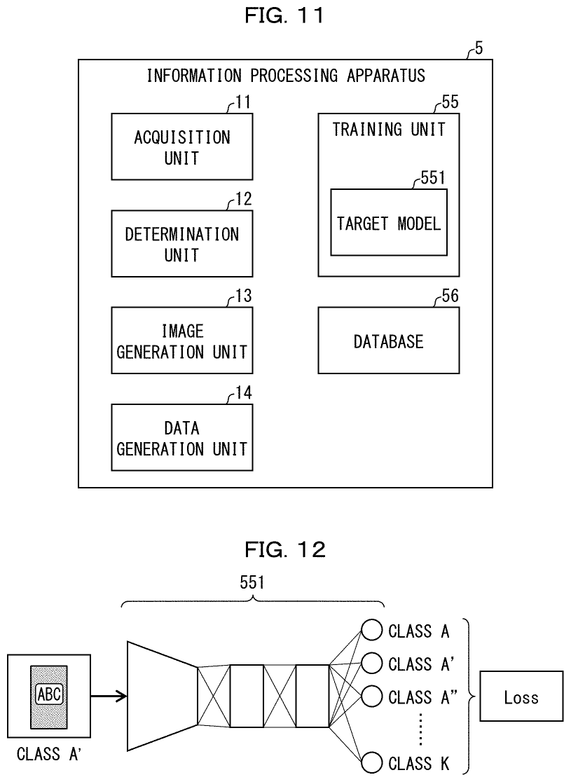

FIG. 11 is a block diagram illustrating a configuration of an information processing apparatus 5 in accordance with a fourth example embodiment. The information processing apparatus 5 includes an acquisition unit 11, a determination unit 12, an image generation unit 13, a data generation unit 14, a training unit 55, and a database 56. The acquisition unit 11, the determination unit 12, the image generation unit 13, and the data generation unit 14 are the same as the respective units described in the second and third embodiments.

As illustrated in FIG. 11, the training unit 55 includes a target model 551 to be trained. The target model 551 is an identifier that identifies, from an image of a product, a class of the product. In the database 56, a plurality of new images generated from the original image by the data generation means 14 are recorded together with an original image. The training unit 55 is an aspect of the “training means” recited in the claims.

The training unit 55 trains the target model 551 with reference to data generated by the data generation means 14. Specifically, the training unit 55 acquires a new image generated by the data generation means 14 from the database 56 and inputs the acquired image into the target model 551. Then, the training unit 55 trains the target model 551 so that an identification result output by the target model 551 is correct. The correct identification result is a result, in response to input of a new image, such that the new image does not belong to any of classes to which the original images registered in the database 56 belong. Note that the training unit 55 may acquire the original image from the database 56 and input the acquired original image into the target model 551 to train the target model 551 so that the target model 551 outputs a correct class. Further, the target model 551 may be the same identification model as the model 451 of the identification unit 45 described for the information processing apparatus 4.

FIG. 12 is a schematic diagram illustrating a configuration of the target model 551 to be trained. The target model 551 is a convolutional neural network that includes a plurality of layers, as illustrated in FIG. 12. When a new image that belongs to class A′ is input to the target model 551, as an output, a class to which the new image is presumed to belong and the degree of reliability thereof are output from the target model 551. Note that class A which is an output result indicates a class to which the original image corresponding to the new image belonging to the class A′ belongs. Class A″ indicates a class to which another new image generated from the same original image belongs. Class K indicates a class differing from the class A among classes of the original image.

The training unit 55 calculates a loss value (Loss) of output of the target model 551 and trains the target model 551 so that the loss value decreases. The loss value is, as an example, a total value of the degree of reliability of classes other than a correct class. For example, in a case where the degree of reliability of the class A is output as 0.10, the degree of reliability of the class A′ (correct class) is output as 0.80, the degree of reliability of the class A″ is output as 0.05, and the degree of reliability of the class K is output as 0.05, the loss value is 0.2. The training of the target model 551 by the training unit 55 refers to updating a weight of a function expression in each layer of a convolutional neural network so that the loss value decreases.

### (Effect of Information Processing Apparatus 5)

As described above, the information processing apparatus 5 in accordance with the present fourth example embodiment employs, in addition to the configurations of the information processing apparatuses 1 to 4 described above, a configuration in which the training unit 55 that trains the target model 551 with reference to data generated by the data generation means 14 is further included. Thus, according to the information processing apparatus 5 in accordance with the present fourth example embodiment, in addition to the effects brought about by the information processing apparatuses 1 to 4 in accordance with the first to third example embodiments, an effect of making it possible to train a target model with use of a generated new image.

### Fifth Example Embodiment

A fifth example embodiment of the present invention will be described in detail with reference to the drawings. The same reference numerals are given to constituent elements which have functions identical with those described in the first to fourth example embodiments, and descriptions as to such constituent elements are not repeated.

### (Configuration of Information Processing Apparatus 6)

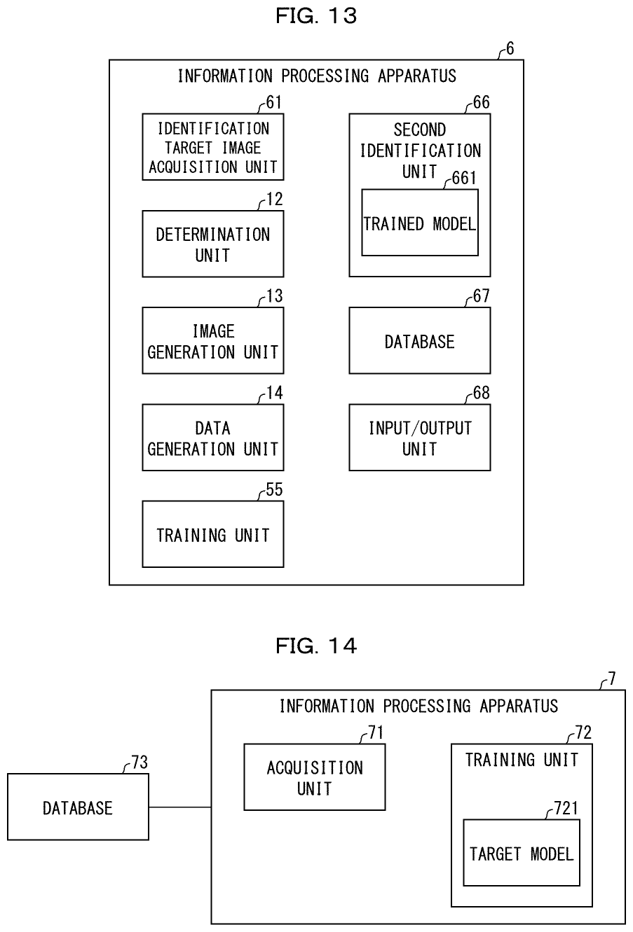

FIG. 13 is a block diagram illustrating a configuration of an information processing apparatus 6 in accordance with a fifth example embodiment. The information processing apparatus 6 includes an identification target image acquisition unit 61, a determination unit 12, an image generation unit 13, a data generation unit 14, a training unit 55, a second identification unit 66, a database 67, and an input/output unit 68. The determination unit 12, the image generation unit 13, the data generation unit 14, the training unit 55, and the database 67 are the same as the respective units described in the fourth embodiment.

The identification target image acquisition unit 61 acquires an identification target image. The identification target image may be an image recorded in the database 67 or may be an image stored outside the information processing apparatus 6. The image stored outside the information processing apparatus 6 is acquired by the identification target image acquisition unit 61 via the input/output unit 68. The second identification unit 66 includes a trained model 661, which is a target model 551 trained by the training unit 55. The second identification unit 66 carries out an identification process involving the identification target image by inputting the identification target image acquired by the identification target image acquisition unit 61 into the trained model 661 trained by the training unit 55.

As an example, when an image is input into the trained model 661, the trained model 661 outputs a class to which the image may possibly belong, together with the degree of reliability. The second identification unit 66 may output, together with the degree of reliability, information pertaining to whether the image fits into any of the registered classes or does not fit into any of the registered classes. The input/output unit 68 is an interface for acquiring an image from the outside or outputting an identification result to the outside.

### (Effect of Information Processing Apparatus 6)

As described above, the information processing apparatus 6 in accordance with the present fifth example embodiment employs, in addition to the configurations of the information processing apparatuses 1 to 5 described above, a configuration in which the second identification unit 66 that inputs the identification target image acquired by the identification target image acquisition unit 61 into the target model 551 (trained model 661) trained by the training unit 55 to thereby carry out an identification process involving the identification target image. Thus, according to the information processing apparatus 6 in accordance with the present fifth example embodiment, in addition to the effects brought about by the information processing apparatuses 1 to 5 in accordance with the first to fourth example embodiments, an effect of making it possible to identify an image with use of a trained target model.

### Sixth Example Embodiment

A sixth example embodiment of the present invention will be described in detail with reference to the drawings. The same reference numerals are given to constituent elements which have functions identical with those described in the first to fifth example embodiments, and descriptions as to such constituent elements are not repeated.

### (Configuration of Information Processing Apparatus 7)

FIG. 14 is a block diagram illustrating a configuration of an information processing apparatus 7 in accordance with a sixth example embodiment. The information processing apparatus 7 includes an acquisition unit 71, a training unit 72, and a database 73. The acquisition unit 71 acquires training data, the training data including a plurality of images, a class label assigned to each of the plurality of images, and identification information that is given to at least one or some images among the plurality of images and that is for identifying an image generation process involving the at least one or some images. The acquisition unit 71 acquires, as an example, training data from the database 73. The training unit 72 includes a target model 721 that is a model to be trained. The training unit 72 trains the target model 721 with reference to the training data acquired by the acquisition unit 71. That is, the training unit 72 inputs the training data into the target model 721 to train the target model 721 so that the loss value of the identification result output from the target model 721 decreases. The database 73 records the training data.

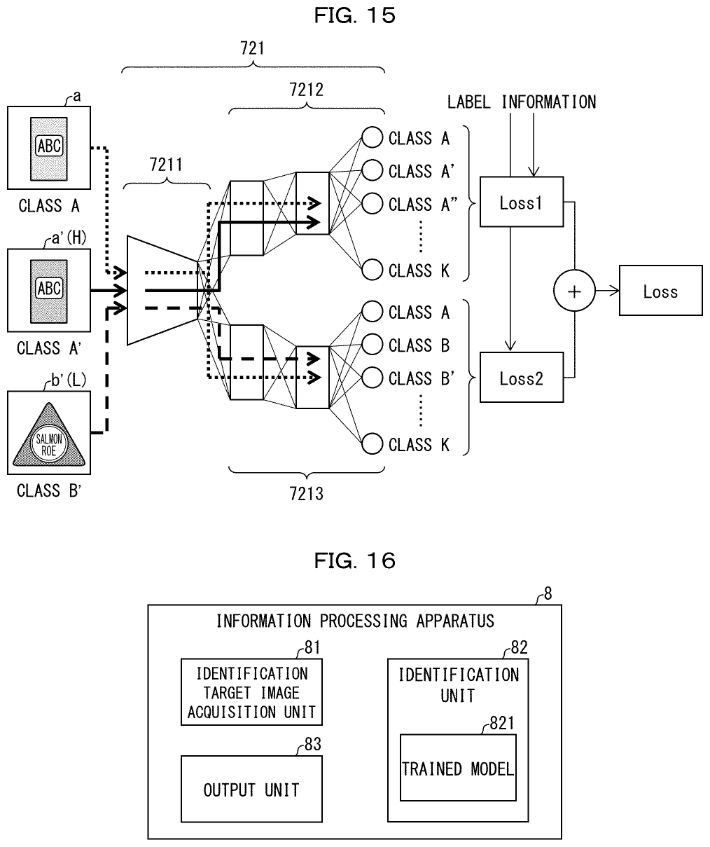

As an example, the target model 721 may include, as an example, two layers based on a convolutional neural network, as illustrated in FIG. 15. One layer is a common layer 7211 that is applied regardless of the identification information, and the other layer is branch layers 7212 and 7213 that are selectively applied according to the identification information. The branch layer 7212 is trained so as to have a high capability of identifying an image of a pattern in which a hue is changed. On the other hand, the branch layer 7213 is trained so as to have a high capability of identifying an image of a pattern in which characters are changed.

The identification information given to the image is information indicating what kind of image the image is. As an example, the identification information is information indicating by what method the image has been generated. For example, as illustrated in FIG. 15, identification information “H” is assigned to an image a′(H) of class A′ generated by changing the hue of an image a of class A. Further, an image b′(L) of class B′ generated by changing characters from an original image (not illustrated) of class B is given identification information “L”. Note that the image a of class A is given no identification information.

In a case where the image a′(H) is input into the target model 721, image processing is carried out with use of the common layer 7211 and the branch layer 7212, as indicated by a solid line in FIG. 15. The training unit 72 trains the target model 721 so that a total loss value (Loss 1) of output values output from the branch layer 7212 decreases.

On the other hand, in a case where the image b′(L) is input into the target model 721, image processing is carried out with use of the common layer 7211 and the branch layer 7213, as indicated by a thick broken line in FIG. 15. The training unit 72 trains the target model 721 so that a total loss value (Loss 2) of output values output from the branch layer 7213 decreases.

Note that, in a case where the image a is input into the target model 721, image processing may be carried out with use of the common layer 7211 and both the branch layers 7212 and 7213, for example, as indicated by thin broken lines in FIG. 15. The training unit 72 trains the target model 721 so that a total value (Loss) of the total loss value (Loss 1) of the output values output from the branch layer 7212 and the total loss value (Loss 2) of the output values output from the branch layer 7213 decreases.

Thus, by using image processing layers suitable for an image in accordance with identification information indicating, for example, how the image was generated, it is possible to further improve the identification accuracy of the image.

### (Effect of Information Processing Apparatus 7)

As described above, the information processing apparatus 7 in accordance with the present example embodiment employs a configuration in which the acquisition unit 71 that acquires training data, the training data including a plurality of images, a class label assigned to each of the plurality of images, and identification information that is given to at least one or some images among the plurality of images and that is for identifying an image generation process involving the at least one or some images, and the training unit 72 that trains the target model 721 with reference to the training data acquired by the acquisition unit 71 are included, and the target model 721 includes the common layer 7211 that is applied regardless of the identification information and the branch layers 7212 and 7213 that are selectively applied in accordance with the identification information. Thus, according to the information processing apparatus 7 in accordance with the present example embodiment, in addition to the effect brought about by the information processing apparatus 1 in accordance with the first example embodiment, an effect of making it possible to improve the identification accuracy by changing an image processing path in accordance with the characteristics of an image.

### Seventh Example Embodiment

A seventh example embodiment of the present invention will be described in detail with reference to the drawings. The same reference numerals are given to constituent elements which have functions identical with those described in the first to sixth example embodiments, and descriptions as to such constituent elements are not repeated.

### (Configuration of Information Processing Apparatus 8)

FIG. 16 is a block diagram illustrating a configuration of an information processing apparatus 8 in accordance with a seventh example embodiment. The information processing apparatus 8 includes an identification target image acquisition unit 81, an identification unit 82, and an output unit 83. The identification target image acquisition unit 81 acquires an identification target image. The identification target image acquisition unit 81 may acquire the identification target image from a memory (not illustrated) or an external database (not illustrated). The identification unit 82 includes a trained model 821, inputs the identification target image acquired by the identification target image acquisition unit 81 into the trained model 821 to thereby carry out an identification process involving the identification target image, and outputs the result of the identification process. The output unit 83 is an interface that outputs the result of the identification process output from the trained model 821 to the outside.

The trained model 821 is a model trained with use of training data, the training data including an image that is assigned a label corresponding to a first class and an image that is generated from the image being assigned the label corresponding to the first class and that is assigned a label corresponding to any of one or more second classes, the one or more second classes differing from the first class. The first class corresponds to the class of the original image described above. The second class image corresponds to the pseudo class described above.

That is, the trained model 821 is an image identification model trained with use of data generated by the information processing apparatuses (information processing systems) 1 to 4 described above. Alternatively, the trained model 821 is a model equivalent to the target model 551 that is trained by the training unit 55 of the information processing apparatus 5, the trained model 661 that is included in the second identification unit 66 of the information processing apparatus 6, or the target model 721 that is trained by the training unit 72 of the information processing apparatus 7. This configuration enables the information processing apparatus 8 to identify the acquired identification target image.

The identification unit 82 outputs any information in any output format. The identification unit 82 may output, as a result of the identification process, information pertaining to whether the identification target image belongs to the first class or any of the one or more second classes. For example, the identification unit 82 may output the first class and/or the second class to which the identification target image may possibly belong and the degree(s) of reliability (e.g., probability) of the first class and/or the second class. With this configuration, it is possible to output a plurality of possible classes and the degrees of reliability thereof.

Alternatively, in a case where the output of the trained model 821 indicates that the identification target image belongs to any of one or more second classes, the identification unit 82 may output, as a result of the identification process, information indicating that the identification target image belongs to the first class. For example, in a case where the output of the trained model 821 indicates that the identification target image belongs to any of the second classes (pseudo-classes), the identification unit 82 may output only the identified class. In this case, the output is simple.

### (Flow of Image Inference Method S6)

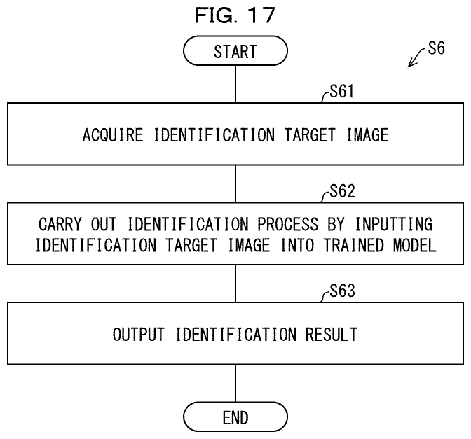

Next, a flow of an information processing method (inference method) S6 of a class of an image carried out by the information processing apparatus 8 will be described with reference to the drawing. FIG. 17 is a flowchart illustrating a flow of the information processing method S6. As illustrated in FIG. 17, the information processing method S6 includes the following steps.

### (Step S61)

In step S61, the identification target image acquisition unit 81 acquires an identification target image.

### (Step S62)

In step S62, the identification unit 82 inputs the identification target image acquired by the identification target image acquisition unit 81 into the trained model 821 to thereby carry out an identification process involving the identification target image. The trained model 821 is as described earlier.

### (Step S63)

In step S63, the identification unit 82 (or the output unit 83) outputs the result of the identification process carried out by the identification unit 82. Furthermore, the output unit 83 may output the identification result to the outside.

### (Configuration and Effect of Information Processing Apparatus 8 and Inference Method S6)

The information processing apparatus 8 in accordance with the seventh example embodiment includes: the identification target image acquisition unit 81 that acquires an identification target image; and an identification unit 82 that inputs the identification target image acquired by the identification target image acquisition unit 81 into the trained model 821 to thereby carry out an identification process involving the identification target image. Further, the inference method S6 includes: acquiring an identification target image; and inputting the identification target image acquired by the identification target image acquisition means into the trained model 821 to thereby carry out an identification process involving the identification target image.

Thus, according to the information processing apparatus 8 and the inference method S6 in accordance with the present seventh example embodiment, an effect of making it possible to identify an identification target image with use of the trained model 821 trained with use of a new image is obtained.

### EXAMPLES

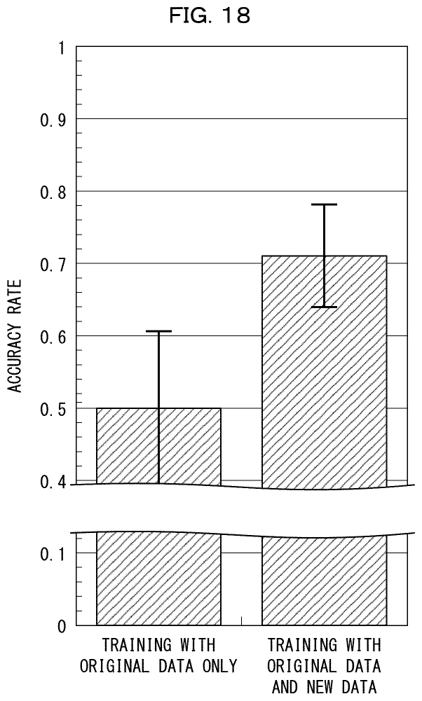

Next, Example will be described. FIG. 18 is a graph showing an accuracy rate of an identifier trained with use of only original image data and an accuracy rate of an identifier trained with use of, in addition to an original image, and a new image generated from the original image. In this Example, the identifier was caused to identify whether an input image belongs to any class of 50 classes registered in the identifier or the input image does not belong to any of the registered classes. Note that the accuracy rate is a rate of the number of images for which the identifier identifies a correct registration class under the condition in which the parameter of the identifier is set so that the rate at which an image of an unregistered class is erroneously identified as an image of a registered class is not higher than 5%.

A bar graph on the left-hand side of the graph of FIG. 18 is the accuracy rate of the identifier trained with use of only the original image of a registered class. A bar graph on the right-hand side is the accuracy rate of the identifier trained with use of not only the original image of the registered class but also a new image. As shown in FIG. 18, the accuracy rate of the identifier trained with use of only the original image of the registered class was 0.5, but the accuracy rate of the identifier trained with use of not only the original image of the registered class but also the new image improved to 0.71.

As described above, the new image generated by using the information processing apparatus in accordance with the present example embodiment was proved to serve as training data effective for training the identifier.

### [Software Implementation Example]

Some or all of functions of the information processing apparatuses 1 and 3 to 8 and the information processing system 2 (all of which will be collectively referred to as “information processing apparatus 1 or the like) can be realized by hardware such as an integrated circuit (IC chip) or can be alternatively realized by software.

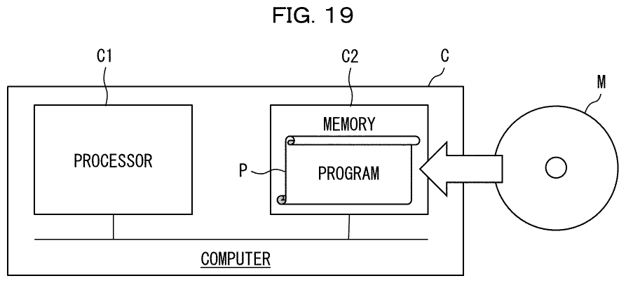

In the latter case, the information processing apparatus 1 or the like is realized by, for example, a computer that executes instructions of a program that is software realizing the foregoing functions. FIG. 19 illustrates an example of such a computer (hereinafter, referred to as “computer C”). The computer C includes at least one processor C1 and at least one memory C2. The at least one memory C2 stores a program P for causing the computer C to operate as the information processing apparatus 1 or the like. In the computer C, the processor C1 reads the program P from the memory C2 and executes the program P, so that the functions of the information processing apparatus 1 or the like are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. As the memory C2, for example, it is possible to use a flash memory, a hard disk drive (HDD), a solid state drive (SSD), or a combination of these.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

Some of or all of the foregoing example embodiments can also be described as below. Note, however, that the present invention is not limited to the following example aspects.

### (Supplementary Note 1)

An information processing apparatus including: an acquisition means for acquiring an original image that belongs to any of a plurality of classes; a determination means for determining a parameter that defines an image generation method; an image generation means for generating, from the original image, a new image with use of the parameter determined by the determination means; and a data generation means for generating data, the data including the new image and a label that is assigned to the new image and that corresponds to a class differing from a class to which the original image belongs.

According to the above-described configuration, in recognition of an image, it is possible to inhibit an image of an unregistered object from being erroneously recognized as an image of a registered object.

### (Supplementary Note 2)

The information processing apparatus according to supplementary note 1, further including a degree-of-difference determination means for deriving a degree of difference between the original image and the new image and comparing the degree of difference with a first threshold value.

According to the above-described configuration, it is possible to reduce a possibility that a new image which is almost the same as the original image is generated.

### (Supplementary Note 3)

The information processing apparatus according to supplementary note 2, wherein, in a case where the degree of difference derived by the degree-of-difference determination means is smaller than the first threshold value, the determination means changes the parameter.

According to the above-described configuration, it is possible to reduce a possibility that a new image having a small degree of difference is generated.

### (Supplementary Note 4)

The information processing apparatus according to supplementary note 3, wherein, in a case where the degree of difference is smaller than the first threshold value, the determination means changes the parameter so that the degree of difference increases.

According to the above-described configuration, it is possible to reduce a possibility that a new image having a small degree of difference is generated.

### (Supplementary Note 5)

The information processing apparatus according to supplementary note 3, wherein, in a case where the degree of difference is smaller than the first threshold value, the determination means changes the parameter in a random manner.

According to the above-described configuration, it is possible to reduce a possibility that a new image having a small degree of difference is generated.

### (Supplementary Note 6)

The information processing apparatus according to any one of supplementary notes 1 to 5, further including an identification means for deriving an identification result by inputting the new image into a model that identifies an image. According to the above-described configuration, it is possible to generate various types of images necessary for appropriate training.

### (Supplementary Note 7)

The information processing apparatus according to supplementary note 6, wherein, in a case where the identification result is a result such that a degree of similarity between the new image and the original image is smaller than a second threshold value, the determination means changes the parameter so that the similarity between the new image and the original image increases.

According to the above-described configuration, it is possible to generate various types of images necessary for appropriate training.

### (Supplementary Note 8)

The information processing apparatus according to supplementary note 6, wherein the identification result includes a class into which the new image is classified, and, in a case where the identification result is a result such that the new image is classified into a class differing from the class to which the original image belongs, the determination means changes the parameter so that the similarity between the new image and the original image increases.

According to the above-described configuration, it is possible to generate various types of images necessary for appropriate training.

### (Supplementary Note 9)

The information processing apparatus according to supplementary note 8, wherein the identification result includes a class into which the new image is classified and a degree of reliability related to the classification into the class, and in a case where the identification result is a result such that the new image is classified into a class differing from the class to which the original image belongs and that the degree of reliability related to the classification into the class is larger than a third threshold value, the determination means changes the parameter so that the similarity between the new image and the original image increases.

According to the above-described configuration, it is possible to generate various types of images for training necessary for appropriate training.

### (Supplementary Note 10)

The information processing apparatus according to any one of supplementary notes 1 to 9, wherein the image generation means generates the new image with use of at least one selected from the group consisting of conversion of at least one or some of colors, replacement of at least one or some of characters, style conversion, interpolation by an image generation model, replacement or superimposition of a portion of an image.

According to the above-described configuration, it is possible to generate a new image from an original image by various methods.

### (Supplementary Note 11)

The information processing apparatus according to any one of supplementary notes 1 to 10, including a training means for training a target model with reference to data generated by the data generation means.

According to the above-described configuration, it is possible to train a target model with use of a generated new image.

### (Supplementary Note 12)

The information processing apparatus according to supplementary note 11, including: an identification target image acquisition means for acquiring an identification target image; and a second identification means for inputting the identification target image acquired by the identification target image acquisition means into the target model trained by the training means to thereby carry out an identification process involving the identification target image.

According to the above-described configuration, it is possible to identify an identification target image with use of a trained target model.

### (Supplementary Note 13)

An information processing apparatus including: an acquisition means for acquiring training data, the training data including a plurality of images, a class label assigned to each of the plurality of images, and identification information that is given to at least one or some images among the plurality of images and that is for identifying an image generation process involving the at least one or some images; and a training means for training a target model with reference to the training data acquired by the acquisition means, the target model including: a common layer that is applied regardless of the identification information; and a branch layer that is selectively applied in accordance with the identification information.

According to the above-described configuration, it is possible to improve the identification accuracy by changing an image processing path in accordance with the characteristics of an image.

### (Supplementary Note 14)

An information processing apparatus including: an identification target image acquisition means for acquiring an identification target image; and an identification means for carrying out an identification process involving the identification target image acquired by the identification target image acquisition means by inputting the identification target image into a model trained with use of training data, the training data including an image that is assigned a label corresponding to a first class and an image that is generated from the image being assigned the label corresponding to the first class and that is assigned a label corresponding to any of one or more second classes, the one or more second classes differing from the first class.

According to the above-described configuration, it is possible for the information processing apparatus to identify an identification target image with use of a trained model that is trained with use of a new image.

### (Supplementary Note 15)

The information processing apparatus according to supplementary note 14, wherein the identification means outputs, as a result of the identification process, information pertaining to belonging of the identification target image to the first class and to any of the one or more second classes.

With this configuration, it is possible to output a plurality of possible classes and the degrees of reliability thereof.

### (Supplementary Note 16)

The information processing apparatus according to supplementary note 14, wherein, in a case where output of the model indicates that the identification target image belongs to any of the one or more second classes, the identification means outputs, as a result of the identification process, information indicating that the identification target image belongs to the first class.

According to the above-described configuration, it is possible to output a simple output result.

### (Supplementary Note 17)

An information processing method including: at least one processor acquiring an original image that belongs to any of a plurality of classes; the at least one processor determining a parameter that defines an image generation method; the at least one processor generating, from the original image, a new image with use of the determined parameter; and the at least one processor generating data, the data including the new image and a label that is assigned to the new image and that corresponds to a class differing from a class to which the original image belongs.

According to the above-described configuration, it is possible to generate training data capable of training an identifier that identifies an image of an article. Therefore, in recognition of an image, it is possible to inhibit an image of an unregistered object from being erroneously recognized as an image of a registered object.

### (Supplementary Note 18)

A data production method including: at least one processor acquiring an original image that belongs to any of a plurality of classes; the at least one processor determining a parameter that defines an image generation method; the at least one processor generating, from the original image, a new image with use of the determined parameter; and the at least one processor generating data, the data including the new image and a label that is assigned to the new image and that corresponds to a class differing from a class to which the original image belongs.

According to the above-described configuration, it is possible to produce training data capable of training an identifier that identifies an image of an article. Therefore, in recognition of an image, it is possible to inhibit an image of an unregistered object from being erroneously recognized as an image of a registered object.

### (Supplementary Note 19)

A program for causing a computer to operate as the information processing apparatus according to any one of supplementary notes 1 to 16, the program causing the computer to function as each of the foregoing means.

### (Supplementary Note 20)

A computer-readable non-transitory storage medium storing the program according to supplementary note 19.

### (Supplementary Note 21)

An information processing method including: acquiring an identification target image; and carrying out an identification process involving the acquired identification target image by inputting the identification target image acquired by the identification target image acquisition means into a model trained with use of training data, the training data including an image that is assigned a label corresponding to a first class and an image that is generated from the image being assigned the label corresponding to the first class and that is assigned a label corresponding to any of one or more second classes, the one or more second classes differing from the first class.

According to the above-described configuration, it is possible to identify an identification target image with use of a trained model that is trained with use of a new image.

### [Additional Remark 3]

Furthermore, some of or all of the foregoing example embodiments can also be described as below.

An information processing apparatus including at least one processor, the at least one processor carrying out: an acquisition process of acquiring an original image that belongs to any of a plurality of classes; a determination process of determining a parameter that defines an image generation method; an image generation process of generating, from the original image, a new image with use of the parameter determined by the determination means; and a data generation process of generating data, the data including the new image and a label that is assigned to the new image and that corresponds to a class differing from a class to which the original image belongs.

Note that the information processing apparatus can further include a memory. The memory can store a program for causing the processor to execute the acquisition process, the determination process, the image generation process, and the data generation process. The program can be stored in a computer-readable non-transitory tangible storage medium.

### REFERENCE SIGNS LIST

1, 3, 4, 5, 6, 7, 8: information processing apparatus
2: information processing system
11, 71: acquisition unit
12: determination unit
13: image generation unit
14: data generation unit
25, 56, 67, 73: database
35: degree-of-difference determination unit
45, 82: identification unit
46, 83: output unit
55, 72: training unit
61, 81: identification target image acquisition unit
66: second identification unit
68: input/output unit

What is claimed is:

1. An information processing apparatus comprising
at least one processor, the at least one processor carrying out:
an acquisition process of acquiring an original image that belongs to any of a plurality of classes;
a determination process of determining a parameter that defines an image generation method;
an image generation process of generating, from the original image, a new image with use of the parameter determined in the determination process; and
a data generation process of generating data, the data including the new image and a label that is assigned to the new image and that corresponds to a class differing from a class to which the original image belongs.

2. The information processing apparatus according to claim 1, wherein the at least one processor further carries out a degree-of-difference determination process of deriving a degree of difference between the original image and the new image and comparing the degree of difference with a first threshold value.

3. The information processing apparatus according to claim 2, wherein, in a case where the degree of difference derived in the degree-of-difference determination process is smaller than the first threshold value, in the determination process, the at least one processor changes the parameter.

4. The information processing apparatus according to claim 3, wherein, in a case where the degree of difference is smaller than the first threshold value, in the determination process, the at least one processor changes the parameter so that the degree of difference increases.

5. The information processing apparatus according to claim 3, wherein, in a case where the degree of difference is smaller than the first threshold value, in the determination process, the at least one processor changes the parameter in a random manner.

6. The information processing apparatus according to claim 1, wherein the at least one processor further carries out a first identification process of deriving an identification result by inputting the new image into a model that identifies an image.

7. The information processing apparatus according to claim 6, wherein, in a case where the identification result is a result such that a degree of similarity between the new image and the original image is smaller than a second threshold value, in the determination process, the at least one processor changes the parameter so that the similarity between the new image and the original image increases.

8. The information processing apparatus according to claim 6, wherein
the identification result includes a class into which the new image is classified, and
in a case where the identification result is a result such that the new image is classified into a class differing from the class to which the original image belongs, in the determination process, the at least one processor changes the parameter so that the similarity between the new image and the original image increases.

9. The information processing apparatus according to claim 8, wherein
the identification result includes a class into which the new image is classified and a degree of reliability related to the classification into the class, and
in a case where the identification result is a result such that the new image is classified into a class differing from the class to which the original image belongs and that the degree of reliability related to the classification into the class is larger than a third threshold value, in the determination process, the at least one processor changes the parameter so that the similarity between the new image and the original image increases.

10. The information processing apparatus according to claim 1, wherein, in the image generation process, the at least one processor generates the new image with use of at least one selected from the group consisting of conversion of at least one or some of colors, replacement of at least one or some of characters, style conversion, interpolation by an image generation model, replacement or superimposition of a portion of an image.

11. The information processing apparatus according to claim 1, wherein the at least one processor further carries out a training process of training a target model with reference to data generated in the data generation process.

12. The information processing apparatus according to claim 11, wherein the at least one processor further carries out:
an identification target image acquisition process of acquiring an identification target image; and
a second identification process of inputting the identification target image acquired in the identification target image acquisition process into the target model trained in the training process to thereby carry out an identification process involving the identification target image.

13.-16. (canceled)

17. An information processing method comprising:
at least one processor acquiring an original image that belongs to any of a plurality of classes;
the at least one processor determining a parameter that defines an image generation method;
the at least one processor generating, from the original image, a new image with use of the determined parameter; and
the at least one processor generating data, the data including the new image and a label that is assigned to the new image and that corresponds to a class differing from a class to which the original image belongs.

18. (canceled)

19. A computer-readable non-transitory storage medium storing a program for causing a computer to function as an information processing apparatus,
the program causing the computer to carry out:
an acquisition process of acquiring an original image that belongs to any of a plurality of classes;
a determination process of determining a parameter that defines an image generation method;
an image generation process of generating, from the original image, a new image with use of the parameter determined in the determination process; and
a data generation process of generating data, the data including the new image and a label that is assigned to the new image and that corresponds to a class differing from a class to which the original image belongs.

20.-21. (canceled)
